(19) United States
(12) Patent Application Publication
(10) Pub. No.: US 2026/0039413 A1
(43) Pub. Date: Feb. 5, 2026

(54) METHODS AND APPARATUSES FOR DETERMINING SIZE OF TRANSPORT BLOCK

(71) Applicant: Lenovo (Beijing) Limited, Beijing (CN)

(72) Inventors: Zhennian Sun, Beijing (CN); Haipeng Lei, Beijing (CN); Xiaodong Yu, Beijing (CN); Xin Guo, Beijing (CN)

(73) Assignee: Lenovo (Beijing) Limited, Beijing (CN)

(21) Appl. No.: 19/099,162

(22) PCT Filed: Aug. 12, 2022
(86) PCT No.: PCT/CN2022/112027

§ 371 Date: Jan. 28, 2025

(51) Int. Cl. H04L 1/00; H04W 16/14; H04W 72/25

(52) U.S. Cl. CPC H04L 1/0006; H04W 16/14; H04W 72/25

(57) ABSTRACT

The present application relates to methods and apparatuses for determining a size of a transport block (TB). An embodiment of the present disclosure provides a user equipment (UE), comprising: a transceiver; and a processor coupled with the transceiver and configured to: determine a size of a TB based on at least one of a first reference number or a second reference number, wherein the first reference number is associated with frequency domain resources for PSSCH transmission in an unlicensed spectrum, and the second reference number is associated with time domain resources for PSSCH transmission; and perform an initial transmission and retransmission(s) of the TB with determined size.

### TECHNICAL FIELD

The present disclosure relates to wireless communication, and particularly relates to methods and apparatuses for determining a size of a transport block (TB).

### BACKGROUND OF THE INVENTION

Interlace resource block (RB)-based transmission may be performed in a sidelink (SL) unlicensed system. The frequency resource allocation granularity is one sub-channel for physical sidelink shared channel (PSSCH) transmission, and one sub-channel may be configured with one or more interlaces. In NR-U, one RB set may consist of 10 interlaces for subcarrier spacing (SCS) of 15 kHz, and may consist of 5 interlaces for 30 kHz respectively.

In the case that the number of RBs in one RB set is not an integer multiple of the total number of interlaces, the interlaces may have unequal number of RBs, which may cause different number of RBs for different sub-channels. In sidelink transmission, the size of a TB for initial transmissions and retransmission(s) should be the same, and the size of the TB may be determined based on the size of RBs included in the sub-channels. Since the sub-channels for different transmissions of a TB are different, the Rx UE may be unclear how to determine the size of the TB.

Furthermore, there may be different starting symbols for different slots for PSSCH transmission, which may also effect the determination of the size of the TB for initial transmissions and retransmission(s).

Therefore, it is advantageous to provide solutions for determining a size of a TB.

### SUMMARY

An embodiment of the present disclosure provides a user equipment (UE), comprising: a transceiver; and a processor coupled with the transceiver and configured to: determine a size of a TB based on at least one of a first reference number or a second reference number, wherein the first reference number is associated with frequency domain resources for PSSCH transmission in an unlicensed spectrum, and the second reference number is associated with time domain resources for PSSCH transmission; and perform an initial transmission and retransmission(s) of the TB with determined size.

In some embodiments, the first reference number includes one of the following: a maximum size of a sub-channel among all configured sub-channels in a resource pool; a minimum size of a sub-channel among all configured sub-channels in the resource pool; or an average size of all configured sub-channels in the resource pool.

In some embodiments, the first reference number includes one of the following: a maximum total number of RBs among multiple possible total numbers of RBs of one or more allocated sub-channels; a minimum total number of RBs among multiple possible total numbers of RBs of one or more allocated sub-channels; or an average total number of RBs of multiple possible total numbers of RBs of one or more allocated sub-channels.

In some embodiments, the second reference number includes one of the following: a maximum total number of symbols among total numbers of symbols included in all slots for PSSCH transmission; a minimum total number of symbols among total numbers of symbols included in all slots for PSSCH transmission; or an average total number of symbols of all total numbers of symbols in all slots for PSSCH transmission.

In some embodiments, a total number of symbols in a slot is determined based on a starting position in the slot.

In some embodiments, the processor is further configured to: transmit an indicator indicating at least one of the first reference number or the second reference number.

In some embodiments, the indicator includes sidelink control information.

Another embodiment of the present disclosure provides a UE, comprising: a transceiver; and a processor coupled with the transceiver and configured to: receive an indicator indicating at least one of a first reference number or a second reference number; determine a size of a TB based on at least one of the first reference number or the second reference number, wherein the first reference number is associated with frequency domain resources for PSSCH transmission in an unlicensed spectrum, and the second reference number is associated with time domain resources for PSSCH transmission; and receive an initial transmission and retransmission(s) of the TB with determined size.

In some embodiments, the first reference number includes one of the following: a maximum size of a sub-channel among all configured sub-channels in a resource pool; a minimum size of a sub-channel among all configured sub-channels in the resource pool; or an average size of all configured sub-channels in the resource pool.

In some embodiments, the first reference number includes one of the following: a maximum total number of RBs among multiple possible total numbers of RBs of one or more allocated sub-channels; a minimum total number of RBs among multiple possible total numbers of RBs of one or more allocated sub-channels; or an average total number of RBs of multiple possible total numbers of RBs of one or more allocated sub-channels.

In some embodiments, the second reference number includes one of the following: a maximum total number of symbols among total numbers of symbols included in all slots for PSSCH transmission; a minimum total number of symbols among total numbers of symbols included in all slots for PSSCH transmission; or an average total number of symbols of all total numbers of symbols in all slots for PSSCH transmission.

In some embodiments, a total number of symbols in a slot is determined based on a starting position in the slot.

In some embodiments, the indicator includes sidelink control information.

Yet another embodiment of the present disclosure provides a method performed by a UE, comprising: determining a size of a TB based on at least one of a first reference number or a second reference number, wherein the first reference number is associated with frequency domain resources for PSSCH transmission in an unlicensed spectrum, and the second reference number is associated with time domain resources for PSSCH transmission; and performing an initial transmission and retransmission(s) of the TB with determined size.

Still another embodiment of the present disclosure provides a method performed by a UE, comprising: receiving an indicator indicating at least one of a first reference number or a second reference number; determining a size of a transport block (TB) based on at least one of the first reference number or the second reference number, wherein the first reference number is associated with frequency domain resources for PSSCH transmission in an unlicensed spectrum, and the second reference number is associated with time domain resources for PSSCH transmission; and receiving an initial transmission and retransmission(s) of the TB with determined size.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2 illustrates an interlaced structure in the frequency domain according to some embodiments of the present disclosure.

FIG. 3 illustrates multiple transmissions of a TB according to some embodiments of the present disclosure.

FIG. 4 illustrates multiple transmissions of a TB according to some embodiments of the present disclosure.

FIG. 5 illustrates a method performed by a Tx UE for determining a size of a TB according to some embodiments of the present disclosure.

FIG. 6 illustrates a method performed by an Rx UE for determining a size of a TB according to some embodiments of the present disclosure.

FIG. 7 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

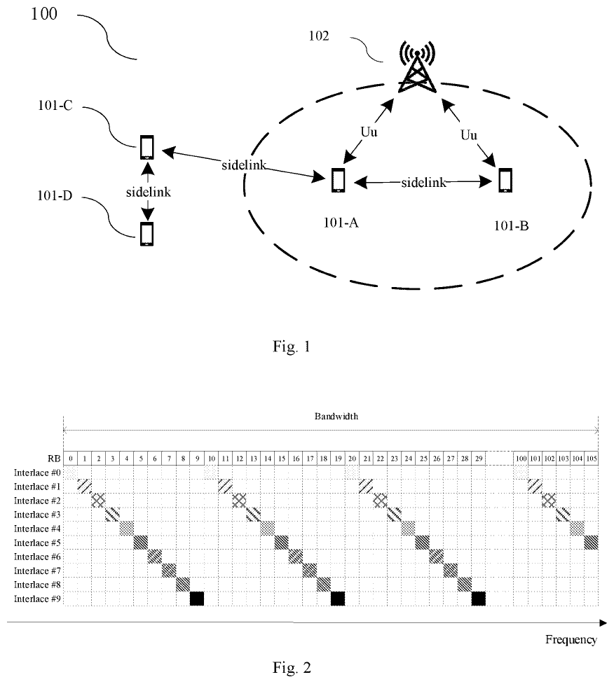

FIG. 1 illustrates a wireless communication system 100 (e.g., an SL-U communication system) in accordance with some embodiments of the present disclosure.

As shown in FIG. 1, the wireless communication system 100 includes a base station (e.g., BS 102), and some UEs (e.g., UE 101-A, UE 101-B, UE 101-C, and UE 101-D). UE 101-A and UE 101-B are within the coverage of BS 102, and UE 101-C and UE 101-D are outside the coverage of BS 102. UE 101-A, UE 101-B, UE 101-C, and UE 101-D may perform sidelink unicast transmission, sidelink groupcast transmission, or sidelink broadcast transmission in an unlicensed spectrum, such as the SL BWP. UE 101-A, UE 101-B, UE 101-C, and UE 101-D may be referred to as an SL UE. It is contemplated that, in accordance with some other embodiments of the present disclosure, an SL-U communication system may include more BSs and more or fewer SL UEs.

In addition, although the SL UEs as shown in FIG. 1 are illustrated in the shape of a cellphone, it is contemplated that an SL communication system may include any type of UE (e.g., a roadmap device, a cell phone, a computer, a laptop, IoT device or other type of device) in accordance with some other embodiments of the present disclosure.

According to some embodiments of FIG. 1, UE 101-A may function as a Tx UE, and UE 101-B, UE 101-C, and UE 101-D may function as Rx UEs. UE 101-A may exchange SL messages with UE 101-B or UE 101-C through a sidelink using, for example, the NR technology or the LTE technology, through PC5 interface as defined in 3GPP documents. UE 101-A may transmit information or data to other UE(s) within the SL-U communication system through sidelink unicast, sidelink groupcast, or sidelink broadcast. For instance, UE 101-A may transmit data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Alternatively, according to some other embodiments of FIG. 1, UE 101-B or UE 101-C may function as a Tx UE and transmit information or data, and UE 101-A may function as an Rx UE and receive information or data from UE 101-B or UE 101-C.

Both UE 101-A and UE 101-B in the embodiments of FIG. 1 may transmit information to BS 102 and receive control information from BS 102, for example, via a Uu interface. BS 102 may define one or more cells, and each cell may have a coverage area. As shown in FIG. 1, both UE 101-A and UE 101-B are within the coverage of BS 102, while UE 101-C and UE 101-D are not.

The BS 102 as illustrated and shown in FIG. 1 may not be a specific base station, but may be any base station(s) in the SL-U communication system. For example, assuming that the SL-U communication system includes two BSs, UE 101-A being within a coverage area of any one the two BSs may be called as a case that UE 101-A is within the coverage of a BS in the SL-U communication system; and only UE 101-A being outside of coverage area(s) of both BSs may be called as a case that UE 101-A is outside of the coverage of a BS in the SL-U communication system.

UEs may operate in different modes. At least the following two sidelink resource allocation modes are defined for sidelink communication: resource allocation mode 1: a BS may schedule a sidelink resource(s) to be used by a UE for sidelink transmission(s); and resource allocation mode 2: a UE may determine a sidelink transmission resource(s) within sidelink resources configured by a BS or network, or pre-configured sidelink resources. In resource allocation mode 2, a BS may not schedule the sidelink resources for a UE. In FIG. 1, UE 101-A and UE 101-B may be in resource allocation mode 1, and UE 101-C and UE 101-D may be in resource allocation mode 2. In some other cases, UE 101-A and UE 101-B may also operate in resource allocation mode 2. Hereinafter in the present disclosure, “mode 1” may refer to resource allocation mode 1, and “mode 2” may refer to resource allocation mode 2.

FIG. 2 illustrates an interlaced structure in the frequency domain according to some embodiments of the present disclosure.

FIG. 2 shows a frequency band with a bandwidth of 20 MHz and an SCS of 15 kHz, and the number of RBs in the frequency band equals 106, which includes RB #0, RB #1, . . . , RB #105. 10 interlaces, e.g., interlace #0, interlace #1, . . . , and interlace #9, are included in the frequency band.

In particular, interlace #0 includes 11 RBs, which are: RB #0, RB #10, . . . . RB #90, and RB #100. Similarly, interlace #1 includes 11 RBs, which are: RB #1, RB #11, . . . , and RB #101. . . . Interlace #5 includes 11 RBs, which are: RB #5, RB #15, . . . , and RB #105. That is, for interlace #0 to interlace #5, each interlace includes 11 RBs.

Interlace #6 includes 10 RBs, which are: RB #6, RB #16, . . . , and RB #96. Similarly, interlace #7 includes 10 RBs, which are: RB #7, RB #17, . . . , and RB #97. . . . Interlace #9 includes 10 RBs, which are: RB #9, RB #19, . . . , and RB #99. That is, for interlace #6 to interlace #9, each interlace includes 10 RBs.

In a SL-U system, the UE may perform a channel sensing operation, such as a listen before talk (LBT) procedure, before any transmission. The granularity of the channel sensing operation may be a RB set. The size of the RB set may be from 100 RBs to 110 RBs for 15 kHz SCS, or from 50 RBs to 55 RBs except for at most one RB set which may contain 56 RBs for 30 kHz SCS.

When the total number of RBs is not an integer multiple of the total number of interlaces, the interlaces may have unequal number of RBs. For example, as shown in FIG. 2, each interlace of interlace #0 to interlace #5 includes 11 RBs, and each interlace of interlace #6 to interlace #9 includes 10 RBs.

The granularity of PSSCH transmission is one sub-channel and each sub-channel may consist of some interlaces. For example, for SCS=15 kHz, 5 sub-channels may be configured, and each sub-channel may consist of 2 interlaces:
sub-channel #0 consists of interlace #0 and interlace #1, thus a total number of 22 RBs is included in sub-channel #0;
sub-channel #1 consists of interlace #2 and interlace #3, thus a total number of 22 RBs is included in sub-channel #1;
sub-channel #2 consists of interlace #4 and interlace #5, thus a total number of 22 RBs is included in sub-channel #2;
sub-channel #3 consists of interlace #6 and interlace #7, thus a total number of 20 RBs is included in sub-channel #3; and
sub-channel #4 consists of interlace #8 and interlace #9, thus a total number of 20 RBs is included in sub-channel #4.

For transmitting a TB, the initial transmission and the re-transmission(s) of the TB should have the same size, that is, the size of the TB for the initial transmission and the retransmission(s) should be the same. However, the Tx UE and/or the Rx UE may not be clear how to determine the size of the TB based on a size of the sub-channel since the different sub-channels may include different number of RBs.

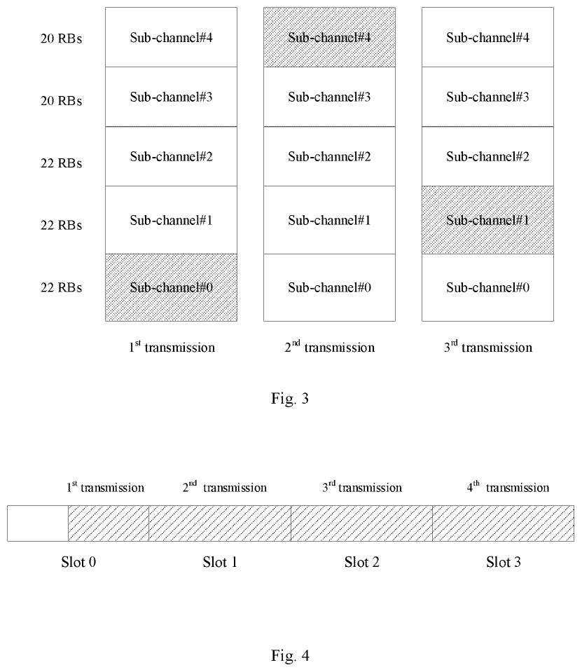

FIG. 3 illustrates multiple transmissions of a TB according to some embodiments of the present disclosure.

In FIG. 3, the 1^{st} transmission (i.e. the initial transmission of a TB) is performed in sub-channel #0, which includes 22 RBs, the 2^{nd} transmission (i.e. the retransmission of the TB) is performed in sub-channel #4, which includes 20 RBs, and the 3^{rd} transmission (i.e. the retransmission of the TB) is performed in sub-channel #2, which includes 22 RBs, the Tx UE may determine the a size of the TB for the 1^{st} transmission, the 2^{nd} transmission and the 3^{rd} transmission. However, at the Rx UE side, the size of the TB is unclear, in other words, the Rx UE does not know how to determine the size of the TB.

FIG. 4 illustrates multiple transmissions of a TB according to some embodiments of the present disclosure.

4 slots are illustrated in FIG. 4, i.e. slot #0, slot #1, slot #2, and slot #3. The Tx UE may perform the 1^{st} transmission (i.e. the initial transmission of a TB) in slot #0, the 2^{nd} transmission in slot #1, the 3^{rd} transmission in slot #2, and the 4^{th} transmission in slot #3 (i.e. the retransmissions of the TB). When multiple starting positions is supported, the UE may perform the 1^{st} transmission with less symbols than the slot-based transmission if the UE successfully accesses the channel with LBT, and perform the 2^{nd}, the 3^{rd}, the 4^{th} transmission in the subsequent slots.

For example, in slot #0, an additional starting symbol may be configured. For example, the additional starting symbol may be symbol #7. The UE may perform the 1^{st} transmission in symbol #7 to symbol #13. In some other cases, the automatic gain control (AGC) symbols, the gap symbol may be excluded from the available symbols for the transmission of the TB.

With the different numbers of symbols in different slots for PSSCH transmission, the Tx UE also need to ensure the same size of the TB for all the transmissions of the TB. That is, the Tx UE may determine a size of the TB with both sub-slot and slot based transmissions.

The present disclosure proposes some solutions for determining a size of a TB with different sub-channel sizes for interlace RB-based sub-channels, and determining a size of a TB with different total numbers of symbols in different slots.

### Solution 1

In Solution 1, the UE may be mandatory to use the sub-channels with the same size (for example, the sub-channels with the same number of RBs) for initial transmission and re-transmissions of a TB, and UE may determine the size of the TB based on the actual number of RBs allocated for the PSSCH transmission.

In this solution, the Tx UE is only allowed to perform the initial transmission and retransmission(s) of a TB on sub-channels with the same total number of RBs. At Rx UE side, it may determine the size of the TB based on the actual number of RBs allocated for the PSSCH transmission.

For a UE operating in sidelink resource allocation mode 1, since the resources for the transmissions of a TB are allocated by the BS, the BS may ensure that the transmissions of a TB (including the initial transmission and the retransmission(s)) have the same number of RBs.

For a UE operating in sidelink resource allocation mode 2, the UE may perform a sensing and resource selection procedure according to the indicated number of sub-channels by a higher layer, the size of selected sub-channel is the same, so each candidate resource may include the same total number of RBs.

The UE may be mandatory to use the sub-channels with the same total number of RBs for sidelink transmissions of a TB, which may impact the sensing and resource selection procedure. Accordingly, during the sensing and resource selection procedure, the following solutions are proposed.

### Solution 1-1

The UE may report a candidate resource set to its higher layer, and each resource in the candidate resource set may include the same size of frequency domain resources, such as the same total number of RBs.

For example, in the case that the higher layer of the UE indicates a number of sub-channels, such as N sub-channels (N is a positive integer), the UE may determine the possible total numbers of RBs included in the N sub-channels. The UE may determine one total number of RBs among all possible total numbers of RBs, which is to be reported to its higher layer, and may also report a candidate resource set containing one or more sub-channels with the determined total number of RBs.

The determination may be performed with the following options:
Option 1: the UE may determine a total number of RBs based on UE implementation;
Option 2: the UE may determine the maximum number of candidate resources in one slot (e.g. the maximum total number of RBs of a sub-channel in one slot); or
Option 3: the UE may determine the minimum number of candidate resources in one slot (e.g. the minimum total number of RBs of a sub-channel in one slot).

For example, as shown in FIG. 3, in the case that the higher layer of the UE indicates one sub-channel, the possible number of RBs included in one sub-channel may be one of {20, 22} RBs, during the sensing procedure, the UE may determine which number of RBs would be reported to its higher layer. For example, the UE may determine the maximum number of candidate resources in one slot may be reported, then the UE may determine that the total number of RBs to be reported is 22, since sub-channel #0, sub-channel #1, and sub-channel #2, include 22 RBs, the UE may report a candidate resource set containing {sub-channel #0, sub-channel #1, sub-channel #2} based on its sensing result.

For another example, as shown in FIG. 3, in the case that the higher layer of the UE indicates two sub-channels, the possible number of RBs included in one sub-channel may be one of {44, 42, 40} RBs, during the sensing procedure, the UE may determine which number of RBs would be reported to its higher layer. For example, the UE may determine the maximum number of candidate resources in one slot may be reported, and thus the total number of RBs to be reported is 44, since the total number of RBs included in a candidate resource set including sub-channel #0 and sub-channel #1 is 44, and a candidate resource set including sub-channel #1 and sub-channel #2, is 44, the UE may report a candidate resource set containing resource {sub-channel #0, sub-channel #1} and {sub-channel #1, sub-channel #2}. It should be noted that the two selected sub-channels may be continuous in the frequency domain. In some other cases, the two selected sub-channels may be discontinuous in the frequency domain.

After reporting the candidate resource set to its higher layer, the higher layer of the UE may perform resource selection from the candidate resource set, and the selected resources may have the same total number of RBs.

### Solution 1-2

The UE may report a candidate resource set, wherein the resource in the set may include different total numbers of RBs. During the resource selection procedure, the UE may select the resources with the same total number of RBs. In particular, in the resource selection procedure, the UE is only allowed to select the resources for initial transmission and retransmission(s) with the same total number of RBs. For example, the UE may randomly select one resource from the candidate resources for its initial transmission, the selected resource may include a number of RBs. For the re-transmissions of the TB, the UE is only allowed to select the resource also with the same number of RBs from the candidate resource set.

### Solution 2

In solution 2, the UE may perform the transmissions of a TB in sub-channels with different sub-channel sizes. The UE may determine a size of the TB based on a first reference number associated with frequency domain resources for PSSCH transmission in an unlicensed spectrum, specifically, the first reference number may be associated with a sub-channel size (or a size of a sub-channel), or a number of RBs in the resource pool.

In some embodiments, the UE may use determine the size of the TB based on a sub-channel size among all configured sub-channels in a resource pool.

### Solution 2-1

The maximum size of a sub-channel among all configured sub-channels is used to calculate the size of the TB. The configured sub-channels may include different number of RBs, for example, X₁, X₂, . . . , X_{M}, (M is an positive integer), among these sub-channels, there may be one or more sub-channels that include the maximum number of RBs, i.e. max (X₁, X₂, . . . , X_{M}), and the maximum number of RBs is used as the reference number to determine the size of the TB. In some embodiments, M may be two.

For example, as shown in FIG. 3, each of sub-channel #0, sub-channel #1, and sub-channel #2 includes 22 RBs, and each of sub-channel #3 and sub-channel #4 includes 20 RBs, the maximum size of a sub-channel is 22 RBs, and the UE may determine the size of the TB based on 22 RBs.

### Solution 2-2

The minimum size of a sub-channel among all configured sub-channels is used to calculate the size of the TB. The configured sub-channels may include different number of RBs, for example, X₁, X₂, . . . , X_{M}, (M is a positive integer), among these sub-channels, there may be one or more sub-channels that include the minimum number of RBs, i.e. min (X₁, X₂, . . . , X_{M}), and the minimum number of RBs is used as the reference number to determine the size of the TB. In some embodiments, M may be two.

For example, as shown in FIG. 3, each of sub-channel #0, sub-channel #1, and sub-channel #2 includes 22 RBs, and each of sub-channel #3 and sub-channel #4 includes 20 RBs, the minimum size of a sub-channel is 20 RBs, and the UE may determine the size of the TB based on 20 RBs.

### Solution 2-3

The average size of sub-channels among all configured sub-channels is used to calculate the size of the TB. The configured sub-channels may include different number of RBs, for example, the number of RBs may include: X₁, X₂, . . . , X_{M}. The average size of the sub-channel may be (X₁+X₂+X_{M})/M, and is used as the reference number to determine the size of the TB. In some embodiments, M may be two. Alternatively, Among X₁, X₂, . . . , X_{M}, there may be a number of different numbers of RBs, suppose there are three different numbers of RBs, which may be represented as: X_{A}, X_{B}, X_{C}, wherein X_{A}, X_{B}, X_{C} are different from each other. The average size of these different numbers, i.e. (X_{A}+X_{B}+X_{C})/3 may be used as the reference number to determine the size of the TB.

For example, as shown in FIG. 3, each of sub-channel #0, sub-channel #1, and sub-channel #2 includes 22 RBs, and each of sub-channel #3 and sub-channel #4 includes 20 RBs. The different numbers of RBs includes 20 and 22. Therefore, the average size of a sub-channel is (20+22)/2=21 RBs. The UE may determine the size of the TB based on the number: 21 RBs.

In some embodiments, the UE may determine the size of the TB based on possible total numbers of RBs of one or more allocated sub-channels.

### Solution 2-4

The maximum total number of RBs among multiple possible total numbers of RBs of one or more allocated sub-channels may be used to calculate the size of the TB. An allocated sub-channel may include different number of RBs, for example, the number of RBs that may possibly be included in one sub-channel may include: Y₁, Y₂, . . . , Y_{M}.

In some embodiments, M may be two. In the case that one sub-channel is allocated for the PSSCH transmission, the possible total numbers of RBs of the allocated sub-channel may include {Y₁, Y₂}, and the maximum number of RBs, i.e. max (Y₁, Y₂) may be used as the reference number to determine the size of the TB. In the case that two sub-channels are allocated for the PSSCH transmission, the UE may determine all possible total numbers of RBs of the two allocated sub-channels, and the maximum total number of RBs may be used as the reference number to determine the size of the TB. It should be noted that the two allocated sub-channels may be continuous in the frequency domain. In some other cases, the two allocated sub-channels may be discontinuous in the frequency domain.

In the case that Z sub-channels (Z is a positive integer) are allocated for the PSSCH transmission, the UE may determine the possible total numbers of RBs of the Z allocated sub-channels, and use the maximum total number of RBs among these possible total numbers of RBs, to calculate the size of the TB. It should be noted that the Z allocated sub-channels may be continuous in the frequency domain. In some other cases, the Z allocated sub-channels may be discontinuous in the frequency domain.

In the case that all sub-channels are allocated for the PSSCH transmission, the UE may use the total numbers of RBs of all allocated sub-channels, to calculate the size of the TB.

For example, as shown in FIG. 3, in the case that one sub-channel is allocated for the PSSCH transmission, the multiple possible number of RBs included in one sub-channel may include {22, 20}, and the maximum number of RBs is 22, thus 22 RBs is used to calculate the size of the TB.

In the case that two sub-channels are allocated for the PSSCH transmission, the possible total number of RBs included in two sub-channels may include {44, 42, 40}, and the maximum total number of RBs of the two allocated sub-channels is 44, thus 44 RBs is used to calculate the size of the TB.

In the case that three sub-channels are allocated for the PSSCH transmission, the possible total number of RBs included in three sub-channels may include {66, 64, 62}, and the maximum total number of RBs of the three allocated sub-channels is 66, thus 66 RBs is used to calculate the size of the TB.

In the case that four sub-channels are allocated for the PSSCH transmission, the possible total number of RBs included in four sub-channels may include {86, 84}, and the maximum total number of RBs of the four allocated sub-channels is 86, thus 86 RBs is used to calculate the size of the TB.

In the case that five sub-channels are allocated for the PSSCH transmission, that is, all the sub-channels are allocated for the PSSCH transmission, the possible total number of RBs may only be 106, thus 106 RBs is used to calculate the size of the TB.

### Solution 2-5

The minimum total number of RBs among multiple possible total numbers of RBs of one or more allocated sub-channels may be used to calculate the size of the TB. An allocated sub-channel may include different numbers of RBs, for example, the number of RBs that may possibly be included in one sub-channel may include: Y₁, Y₂, . . . , Y_{M}.

In some embodiments, M may be two. In the case that one sub-channel is allocated for the PSSCH transmission, the possible total numbers of RBs of the allocated sub-channel may include {Y₁, Y₂}, and the minimum number of RBs, i.e. min (Y₁, Y₂) may be used as the reference number to determine the size of the TB. In the case that two sub-channels are allocated for the PSSCH transmission, the UE may determine all possible total numbers of RBs of the two allocated sub-channels, and the minimum total number of RBs may be used as the reference number to determine the size of the TB. It should be noted that the two allocated sub-channels may be continuous in the frequency domain. In some other cases, the two allocated sub-channels may be discontinuous in the frequency domain.

In the case that Z sub-channels are allocated for the PSSCH transmission, the UE may determine the possible total numbers of RBs of the Z allocated sub-channels, and use the minimum total number of RBs among these possible total numbers of RBs, to calculate the size of the TB. It should be noted that the Z allocated sub-channels may be continuous in the frequency domain. In some other cases, the Z allocated sub-channels may be discontinuous in the frequency domain.

In the case that all sub-channels are allocated for the PSSCH transmission, the UE may use the total numbers of RBs of all allocated sub-channels, to calculate the size of the TB.

For example, as shown in FIG. 3, in the case that one sub-channel is allocated for the PSSCH transmission, the multiple possible number of RBs included in one sub-channel may include {22, 20}, and the minimum number of RBs is 20, thus 20 RBs is used to calculate the size of the TB.

In the case that two sub-channels are allocated for the PSSCH transmission, the possible total number of RBs included in two sub-channels may include {44, 42, 40}, and the minimum total number of RBs of the two allocated sub-channels is 40, thus 40 RBs is used to calculate the size of the TB.

In the case that three sub-channels are allocated for the PSSCH transmission, the possible total number of RBs included in three sub-channels may include {66, 64, 62}, and the minimum total number of RBs of the three allocated sub-channels is 62, thus 62 RBs is used to calculate the size of the TB.

In the case that four sub-channels are allocated for the PSSCH transmission, the possible total number of RBs included in four sub-channels may include {86, 84}, and the minimum total number of RBs of the four allocated sub-channels is 84, thus 84 RBs is used to calculate the size of the TB.

In the case that five sub-channels are allocated for the PSSCH transmission, that is, all the sub-channels are allocated for the PSSCH transmission, the possible total number of RBs may only be 106, thus 106 RBs is used to calculate the size of the TB.

### Solution 2-6

The average total number of RBs among multiple possible total numbers of RBs of one or more allocated sub-channels may be used to calculate the size of the TB. An allocated sub-channel may include different number of RBs, for example, the number of RBs that may possibly be included in one sub-channel may include: Y₁, Y₂, . . . , Y_{M}.

In some embodiments, M may be two. In the case that one sub-channel is allocated for the PSSCH transmission, the possible total numbers of RBs of the allocated sub-channel may include {Y₁, Y₂}, and the average number of RBs, i.e. (Y₁+Y₂)/2 may be used as the reference number to determine the size of the TB. In the case that two sub-channels are allocated for the PSSCH transmission, the UE may determine all possible total numbers of RBs of the two allocated sub-channels, and the average total number of RBs may be used as the reference number to determine the size of the TB. It should be noted that the two allocated sub-channels may be continuous in the frequency domain. In some other cases, the two allocated sub-channels may be discontinuous in the frequency domain.

In the case that Z sub-channels are allocated for the PSSCH transmission, the UE may determine the possible total numbers of RBs of the Z allocated sub-channels, and use the average total number of RBs among these possible total numbers of RBs, to calculate the size of the TB. It should be noted that the Z allocated sub-channels may be continuous in the frequency domain. In some other cases, the Z allocated sub-channels may be discontinuous in the frequency domain.

In the case that all sub-channels are allocated for the PSSCH transmission, the UE may use the total numbers of RBs of all allocated sub-channels, to calculate the size of the TB.

For example, as shown in FIG. 3, in the case that one sub-channel is allocated for the PSSCH transmission, the multiple possible total number of RBs may include {22, 20}, and the average total number of RBs of multiple possible total numbers of RBs is 21, thus 21 RBs is used to calculate the size of the TB.

In the case that two sub-channels are allocated for the PSSCH transmission, the possible total number of RBs may include {44, 42, 40}, and the average total number of RBs of multiple possible total numbers of RBs of the two allocated sub-channels is 42, thus 42 RBs is used to calculate the size of the TB.

In the case that three sub-channels are allocated for the PSSCH transmission, the possible total number of RBs may include {66, 64, 62}, and the average total number of RBs of multiple possible total numbers of RBs of the three allocated sub-channels is 64, thus 64 RBs is used to calculate the size of the TB.

In the case that four sub-channels are allocated for the PSSCH transmission, the possible total number of RBs may include {86, 84}, and the average total number of RBs of multiple possible total numbers of RBs of the four allocated sub-channels is 85, thus 85 RBs is used to calculate the size of the TB.

In the case that five sub-channels are allocated for the PSSCH transmission, that is, all the sub-channels are allocated for the PSSCH transmission, the possible total number of RBs may only be 106, thus 106 RBs is used to calculate the size of the TB.

With the first reference number associated with a size of a sub-channel or associated with a total number of RBs, the UE may determine the size of the TB, and may perform the initial transmission and retransmission(s) of the TB with the determined size. In other words, the initial transmission and retransmission(s) of the TB has the same size.

After determining the first reference number associated with frequency domain resources for PSSCH transmission in an unlicensed spectrum (i.e. the size of a sub-channel, or a total number of RBs), the Tx UE may transmit an indicator (or an indication, a message, an information element (IE), a field, or the like) indicating the first reference number to the Rx UE. The indicator may be transmitted in the SCI, for example, the 1^{st}-stage SCI or 2^{nd}-stage SCI.

For solutions 2-1 to 2-3, the Tx UE may indicate a size of a sub-channel to the Rx UE. As shown in FIG. 3, the possible sizes of a sub-channel may be {20, 22} RBs. The Tx UE may transmit an indicator in the SCI to the Rx UE, to indicate the size of a sub-channel (e.g. 20 RBs, or 22 RBs), which is used to calculate the size of the TB. At Rx UE side, after receiving the indictor, the Rx UE may determine the size of the TB based on the reference size of the sub-channel, and perform SL reception with the determined size of the TB.

To ensure a fixed payload size of the indicator, the size of the indicator is based on the possible size of the sub-channel. For example, in solution 2-1, the indicator may include 1 bit, with one value (for example “0”) indicating a size of 20 RBs, the other value (for example “1”) indicating a size of 22 RBs. In the case that 105 RBs (which may include RB #0, . . . , RB #104) is configured in the RB set, the possible size of a sub-channel may include: {22, 21, 20} RBs. For example, each of sub-channel #0 and sub-channel #1 includes 22 RBs, sub-channel #2 includes 21 RBs, and each of sub-channel #3 and sub-channel #4 includes 20 RBs. The indicator may include 2 bits, with one value (for example “00”) indicating a size of 20 RBs, another value (for example “01”) indicating a size of 21 RBs, and another value (for example “10”) indicating a size of 22 RBs.

For solutions 2-4 to 2-6, the Tx UE may indicate a size of total number of RBs to the Rx UE.

As described in solutions 2-4 to 2-6, in the case that one sub-channel is allocated, the possible total numbers of RBs may be {20, 22} RBs; in the case that two sub-channels are allocated, the possible total numbers of RBs may be {44, 42, 40}; in the case that three sub-channels are allocated, the possible total number of RBs may be {66, 64, 62}; in the case that four sub-channels are allocated, the possible total number of RBs may be {86,84}; in the case that five sub-channels (all sub-channels) are allocated, the possible total number of RBs may be 106.

To ensure the same payload size of the indicator, the maximum size of the possible total number of RBs for different allocated sub-channels may be used to calculate the size of the indicator, as in the above cases, the maximum size of possible total number of RBs set is 3, so 2 bits are needed for the indicator.

### Solution 3

In solution 3, the UE may perform the transmissions of a TB in slots with different lengths (e.g. slots with different number of symbols). The UE may determine a size of the TB based on a second reference number which is associated with a total number of symbols in a slot for PSSCH transmission.

The present disclosure proposes that in addition to the starting of a slot, multiple starting positions may be configured. For example, in the case that a UE successfully accesses the channel in some symbol of a slot, the UE may perform sidelink transmission within the slot. To ensure the same size of a TB for sub-slot transmission and slot-based transmission of a TB, the present disclosure proposes the following solutions:

### Solution 3-1

The maximum total number of symbols among total numbers of symbols included in all slots for PSSCH transmission is used to calculate the size of the TB. The total numbers of symbols included in different slots may include S₁, S₂, . . . , S_{Q}, (Q is the number of slots). Among these slots, there may be one or more slots that include the maximum total number of symbols, i.e. max (S₁, S₂, . . . , S_{Q}), and the maximum total number of symbols is used as the reference number to determine the size of the TB.

For example, in FIG. 4, it is supposed that a starting position from 7^{th} symbol in slot #0 is configured as an additional starting position for PSSCH transmission, thus the total number of symbols included in slot #0 is 7 (symbol #7, symbol #8, . . . , symbol #13). For slot #1, slot #2, and slot #3, the total number of symbols included in slot #1, slot #2, and slot #3 is 14. Therefore, the maximum total number of symbols among total numbers of symbols included in all slots for PSSCH transmission is 14. The UE may determine the size of the TB based on 14 symbols.

In some other cases, some symbols may be excluded, such as the AGC symbol, the guard symbol, the gap symbol, etc., thus the total number of symbols included in a slot may be less than 14, for example, 12, 13, or other numbers. For example, in FIG. 4, the total number of symbols included in slot #1, slot #2, and slot #3 may be 12. Therefore, the maximum total number of symbols among total numbers of symbols included in all slots for PSSCH transmission is 12. The UE may determine the size of the TB based on the reference number of symbols: 12.

### Solution 3-2

The minimum total number of symbols among total numbers of symbols included in all slots for PSSCH transmission is used to calculate the size of the TB. The total numbers of symbols included in different slots may be S₁, S₂, . . . , S_{Q}, (Q is the number of slots). Among these slots, there may be one or more slots that include the minimum total number of symbols, i.e. min (S₁, S₂, . . . , S_{Q}), and the minimum total number of symbols is used as the reference number to determine the size of the TB.

For example, in FIG. 4, it is supposed that one starting position from 7^{th} symbol in slot #0 is configured as an additional starting position for PSSCH transmission, thus the total number of symbols included in slot #0 is 7 (symbol #7, symbol #8, . . . , symbol #13). For slot #1, slot #2, and slot #3, the total number of symbols included in slot #1, slot #2, and slot #3 is 14. Therefore, the minimum total number of symbols among total numbers of symbols included in all slots for PSSCH transmission is 7. The UE may determine the size of the TB based on 14 symbols.

In some other cases, some symbols may be excluded, such as the AGC symbol, the guard symbol, the gap symbol, etc., thus the total number of symbols included in slot #0 may be less than 7, for example, 5, 6, or other numbers. Therefore, the minimum total number of symbols among total numbers of symbols included in all slots for PSSCH transmission is 5, or 6, or other numbers. The UE may determine the size of the TB based on the reference number of symbols: 5, or 6, or other numbers.

### Solution 3-3

The average total number of symbols among total numbers of symbols included in all slots for PSSCH transmission is used to calculate the size of the TB. The total numbers of symbols included each slot of Q slots may be S₁, S₂, . . . , S_{Q}, (Q is the total number of slots, and S₁, S₂, . . . , S_{Q} may be the same or different from each other). The average total number is: (S₁+S₂+ . . . +S_{Q})/Q. Alternatively, the average total number of symbols among different total numbers of symbols included in all slots for PSSCH transmission is used to calculate the size of the TB. The slots may include different total numbers of symbols, for example, S₁, S₂, . . . , S_{P}, (P is the number of different total numbers of symbols in the slots, P is smaller than or equal to Q, and S₁, S₂, . . . , S_{P} are different from each other). The average total number is: (S₁+S₂+ . . . +S_{P})/P. The average total number of symbols may be used as the reference number to determine the size of the TB.

For example, in FIG. 4, it is supposed that one starting position from 7^{th} symbol in slot #0 is configured as an additional starting position for PSSCH transmission, thus the total number of symbols included in slot #0 is 7 (symbol #7, symbol #8, . . . , symbol #13). For slot #1, slot #2, and slot #3, the total number of symbols included in slot #1, slot #2, and slot #3 is 14. Therefore, there are two different total numbers of symbols, which are: 7 and 14. The average total number of symbols among different total numbers of symbols is (7+14)/2=10.5. The UE may determine the size of the TB based on 10.5 symbols.

After determining the second reference number associated with time domain resources for PSSCH transmission (i.e. a total number of symbols), the Tx UE may transmit the second reference number to the Rx UE. In particular, the Tx UE may transmit the second reference number in a similar fashion as transmitting the first reference number, such as transmitting the second reference number in the SCI.

In some other cases, the Tx UE may transmit both the first reference number and the second reference number to the Rx UE, for example, in the SCI.

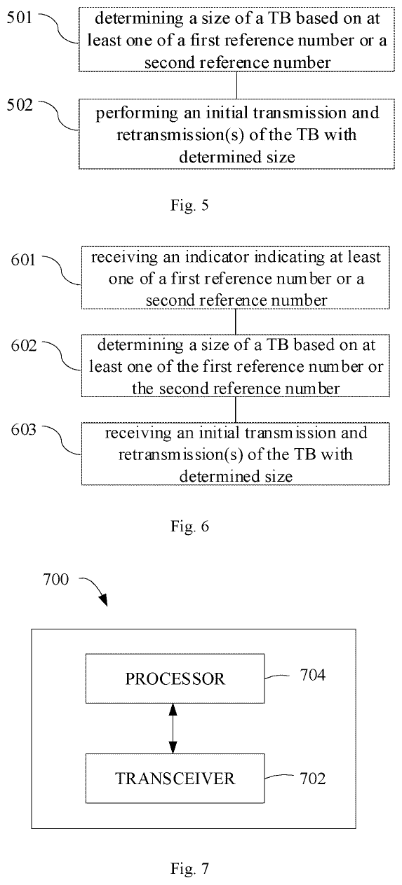

FIG. 5 illustrates a method performed by a Tx UE for determining a size of a TB according to some embodiments of the present disclosure.

In operation 501, the UE, for example, a Tx UE, may determine a size of a TB based on at least one of a first reference number or a second reference number, wherein the first reference number is associated with frequency domain resources for PSSCH transmission in an unlicensed spectrum, and the second reference number is associated with time domain resources for PSSCH transmission. In operation 502, the UE may perform an initial transmission and retransmission(s) of the TB with determined size.

FIG. 6 illustrates a method performed by an Rx UE for determining a size of a TB according to some embodiments of the present disclosure.

In operation 601, the UE, for example, a Rx UE, may receive an indicator indicating at least one of a first reference number or a second reference number.

In operation 602, the UE may determine a size of a TB based on at least one of the first reference number or the second reference number, wherein the first reference number is associated with frequency domain resources for PSSCH transmission in an unlicensed spectrum, and the second reference number is associated with time domain resources for PSSCH transmission.

In operation 603, the UE may receive an initial transmission and retransmission(s) of the TB with determined size.

In some embodiments, the first reference number includes one of the following:
a maximum size of a sub-channel among all configured sub-channels in a resource pool (for example, solution 2-1);
a minimum size of a sub-channel among all configured sub-channels in the resource pool (for example, solution 2-2); or
an average size of all configured sub-channels in the resource pool (for example, solution 2-3).

In some embodiments, the first reference number includes one of the following:
a maximum total number of RBs among multiple possible total numbers of RBs of one or more allocated sub-channels (for example, solution 2-4);
a minimum total number of RBs among multiple possible total numbers of RBs of one or more allocated sub-channels (for example, solution 2-5); or
an average total number of RBs of multiple possible total numbers of RBs of one or more allocated sub-channels (for example, solution 2-6).

In some embodiments, the second reference number includes one of the following:
a maximum total number of symbols among total numbers of symbols included in all slots for PSSCH transmission (for example, solution 3-1);
a minimum total number of symbols among total numbers of symbols included in all slots for PSSCH transmission (for example, solution 3-2); or
an average total number of symbols of all total numbers of symbols in all slots for PSSCH transmission (for example, solution 3-3).

In some embodiments, a total number of symbols in a slot is determined based on a starting position in the slot. For example, the starting position in slot #0 in FIG. 4 may be symbol #7.

In some embodiments, the Tx UE may transmit an indicator indicating at least one of the first reference number or the second reference number. In some embodiments, the indicator may include sidelink control information, for example, the 1^{st} stage SCI or the 2^{nd} stage SCI.

FIG. 7 illustrates a simplified block diagram of an apparatus according to some embodiments of the present disclosure.

As shown in FIG. 7, an example of the apparatus 700 may include at least one processor 704 and at least one transceiver 702 coupled to the processor 704. The apparatus 700 may be a UE, such as a Tx UE or an Rx UE, or any other device with similar functions.

Although in this figure, elements such as the at least one transceiver 702 and processor 704 are described in the singular, the plural is contemplated unless a limitation to the singular is explicitly stated. In some embodiments of the present disclosure, the transceiver 702 may be divided into two devices, such as a receiving circuitry and a transmitting circuitry. In some embodiments of the present disclosure, the apparatus 700 may further include an input device, a memory, and/or other components.

In some embodiments of the present disclosure, the apparatus 700 may be a UE. The transceiver 702 and the processor 704 may interact with each other so as to perform the operations of the UE described in any of FIGS. 1-6. In some embodiments of the present disclosure, the apparatus 700 may be a node. The transceiver 702 and the processor 704 may interact with each other so as to perform the operations of the node described in any of FIGS. 1-6.

In some embodiments of the present disclosure, the apparatus 700 may further include at least one non-transitory computer-readable medium.

For example, in some embodiments of the present disclosure, the non-transitory computer-readable medium may have stored thereon computer-executable instructions to cause the processor 704 to implement the method with respect to the UE as described above. For example, the computer-executable instructions, when executed, cause the processor 704 interacting with transceiver 702 to perform the operations of the UE described in any of FIGS. 1-6.

In some embodiments of the present disclosure, the non-transitory computer-readable medium may have stored thereon computer-executable instructions to cause the processor 704 to implement the method with respect to the node as described above. For example, the computer-executable instructions, when executed, cause the processor 704 interacting with transceiver 702 to perform the operations of the node described in any of FIGS. 1-6.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
determine a size of a transport block (TB) based at least in part on at least one of a first reference number or a second reference number, wherein the first reference number is associated with frequency domain resources for physical sidelink shared channel (PSSCH) transmission in an unlicensed spectrum, and the second reference number is associated with time domain resources for PSSCH transmission; and
perform an initial transmission and at least one retransmission of the TB with the size.

2. The UE of claim 1, wherein the first reference number includes one of:
a maximum size of a sub-channel among all configured sub-channels in a resource pool; or
a minimum size of a sub-channel among all configured sub-channels in the resource pool.

3. The UE of claim 1, wherein the first reference number includes one of:
a maximum total number of resource blocks (RBs) among multiple possible total numbers of RBs of one or more allocated sub-channels;
a minimum total number of RBs among multiple possible total numbers of RBs of one or more allocated sub-channels; or
an average total number of RBs of multiple possible total numbers of RBs of one or more allocated sub-channels.

4. The UE of claim 1, wherein the second reference number includes one of:
a maximum total number of symbols among total numbers of symbols included in all slots for PSSCH transmission; or
a minimum total number of symbols among total numbers of symbols included in all slots for PSSCH transmission.

5. The UE of claim 4, wherein a total number of symbols in a slot is determined based at least in part on a starting position in the slot.

6. The UE of claim 1, wherein the at least one processor is further configured to cause the UE to:
transmit an indicator that indicates at least one of the first reference number or the second reference number.

7. The UE of claim 6, wherein the indicator includes sidelink control information.

8. A user equipment (UE) for wireless communication, comprising:
at least one memory; and
at least one processor coupled with the at least one memory and configured to cause the UE to:
receive an indicator that indicates at least one of a first reference number or a second reference number;
determine a size of a transport block (TB) based at least in part on at least one of the first reference number or the second reference number, wherein the first reference number is associated with frequency domain resources for physical sidelink shared channel (PSSCH) transmission in an unlicensed spectrum, and the second reference number is associated with time domain resources for PSSCH transmission; and
receive an initial transmission and at least one retransmission of the TB with determined size.

9. The UE of claim 8, wherein the first reference number includes one of:
a maximum size of a sub-channel among all configured sub-channels in a resource pool;
a minimum size of a sub-channel among all configured sub-channels in the resource pool; or
an average size of all configured sub-channels in the resource pool.

10. The UE of claim 8, wherein the first reference number includes one of:
a maximum total number of resource blocks (RBs) among multiple possible total numbers of RBs of one or more allocated sub-channels;
a minimum total number of RBs among multiple possible total numbers of RBs of one or more allocated sub-channels; or
an average total number of RBs of multiple possible total numbers of RBs of one or more allocated sub-channels.

11. The UE of claim 8, wherein the second reference number includes one of:
a maximum total number of symbols among total numbers of symbols included in all slots for PSSCH transmission;
a minimum total number of symbols among total numbers of symbols included in all slots for PSSCH transmission; or
an average total number of symbols of all total numbers of symbols in all slots for PSSCH transmission.

12. (canceled)

13. The UE of claim 8, wherein the indicator includes sidelink control information.

14. A method performed by a user equipment (UE), the method comprising:
determining a size of a transport block (TB) based at least in part on at least one of a first reference number or a second reference number, wherein the first reference number is associated with frequency domain resources for physical sidelink shared channel (PSSCH) transmission in an unlicensed spectrum, and the second reference number is associated with time domain resources for PSSCH transmission; and
performing an initial transmission and at least one retransmission of the TB with the size.

15. The method of claim 14, wherein the first reference number includes one of:
a maximum size of a sub-channel among all configured sub-channels in a resource pool; or
a minimum size of a sub-channel among all configured sub-channels in the resource pool.

16. The method of claim 14, wherein the second reference number includes one of:
a maximum total number of symbols among total numbers of symbols included in all slots for PSSCH transmission; or
a minimum total number of symbols among total numbers of symbols included in all slots for PSSCH transmission.

17. The method of claim 16, wherein a total number of symbols in a slot is determined based at least in part on a starting position in the slot.

18. A processor for wireless communication, comprising:
at least one controller coupled with at least one memory and configured to cause the processor to:
determine a size of a transport block (TB) based at least in part on at least one of a first reference number or a second reference number, wherein the first reference number is associated with frequency domain resources for physical sidelink shared channel (PSSCH) transmission in an unlicensed spectrum, and the second reference number is associated with time domain resources for PSSCH transmission; and
perform an initial transmission and at least one retransmission of the TB with the size.

19. The processor of claim 18, wherein the first reference number includes one of:
a maximum size of a sub-channel among all configured sub-channels in a resource pool; or
a minimum size of a sub-channel among all configured sub-channels in the resource pool.

20. The processor of claim 18, wherein the second reference number includes one of:
a maximum total number of symbols among total numbers of symbols included in all slots for PSSCH transmission; or
a minimum total number of symbols among total numbers of symbols included in all slots for PSSCH transmission.

21. The processor of claim 20, wherein a total number of symbols in a slot is determined based at least in part on a starting position in the slot.
